(19) United States
(12) Patent Application Publication
(10) Pub. No.: US 2002/0087368 A1
(43) Pub. Date: Jul. 4, 2002

(54) Method and system for introducing a new material supplier into a product design and manufacturing system

(76) Inventors: Yimin Jin, Glenmont, NY (US); James Paul Barren, Scotia, NY (US); Sarah Elizabeth Morgan, East Greenbush, NY (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 09/682,239

(22) Filed: Aug. 8, 2001

Related U.S. Application Data
(63) Continuation of application No. 09/750,906, filed on Jan. 2, 2001.
(60) Provisional application No. 60/286,984, filed on Apr. 30, 2001.

(51) Int. Cl. G06F 17/60

(52) U.S. Cl. 705/7

(57) ABSTRACT

A method and system for introducing a new supplier into a product design and manufacturing system. Once it has been decided that a need exists and that a new supplier should be investigated for introduction, a plurality of supplier and project information is received through a systematic series of stages, milestones and checklists. A variety of milestone and checklist items are completed for each stage and relevant documentation is received and reviewed. A stage tollgate is then conducted, wherein it is determined whether the project should advance into the next stage. If a stage approval is received, the various milestones and checklists corresponding to the next stage are undertaken. By progressing through all stages, all required information is shared rapidly and efficiently and creates a system of record for new supplier introduction which may be subsequently searched and referenced.

CROSS REFERENCE TO RELATED APPLICATIONS

This application claims the benefit of U.S. patent application Ser. No. 09/750,906 filed Jan. 2, 2001 and U.S. provisional patent application Serial No. 60/286,984 filed Apr. 30, 2001, the disclosures of which are incorporated herein by reference.

### BACKGROUND OF THE INVENTION

The present invention relates generally to systems and processes for initiating and implementing changes in business organizations. More particularly, the present invention relates to providing a comprehensive system for facilitating the introduction of new material suppliers into a product design and manufacturing system.

Conventionally, distributed global manufacturing and design companies have struggled to efficiently and safely introduce new material suppliers due to overarching concerns relating to health and safety regulations, import/export restrictions, supplier qualifications and resources, etc. In addition to problems caused by the supplier introduction, the various sites of the organization may have, over time, promulgated significantly different methods for making such introductions. These differences, further restrict the ability to transition a supplier from one site to another, since the processes involved in qualifying the supplier may differ between sites. Further, a plurality of considerations must be taken into account when determining whether to approve the introduction of a new supplier. Diverse considerations such as material specification issues, environment health and safety issues, and supplier resource issues all impact the determination regarding a particular potential supplier. Since determinations regarding the various elements related to supplier introduction are necessarily made at multiple levels within the organization, the merging of dissimilar systems and the physical documentation associated with each system further compounds the inefficiency in conventional supplier introduction methods.

Therefore, there is a need in the art of supplier introduction processes to facilitate the introduction of new or modified suppliers into the system. There is a further need for a method and system for providing globalized, automated introduction of material suppliers across distributed locations.

### SUMMARY OF THE INVENTION

The present invention overcomes the problems noted above, and provides additional advantages, by providing for a comprehensive method and system for introducing a new supplier into a product design and manufacturing system. Once it has been decided that a need exists and that a new supplier should be investigated for introduction, a plurality of supplier and project information is received through a systematic series of stages, milestones and checklists. A variety of milestone and checklist items are completed for each stage and relevant documentation is received and reviewed. A stage tollgate is then conducted, wherein it is determined whether the project should advance into the next stage. If a stage approval is received, the various milestones and checklists corresponding to the next stage are undertaken. By progressing through all stages, all required information is shared rapidly and efficiently and creates a system of record for new supplier introduction which may be subsequently searched and referenced.

By providing a uniform process for introducing a new material supplier in a product design/manufacturing system, the system and method of the present invention substantially decreases the likelihood of errors being made which introduce costs in both time, resources, and risk. Further, the present system, through its comprehensive, global nature, substantially increases the ability for distributed locations to stay in tune with what each other are doing. Because all suppliers in every location must be introduced in accordance with the above system, added consistency results. In addition to consistency, the above described invention further provides for a uniform system of record for all attempted supplier introductions. Consequently, future developers may more easily determine if a similar introduction has been done previously.

### BRIEF DESCRIPTION OF THE DRAWINGS

The present invention can be understood more completely by reading the following Detailed Description of exemplary embodiments, in conjunction with the accompanying drawings, in which:

FIG. 1 is a flow chart describing a preferred general embodiment for introducing a new supplier into an organization;

FIG. 2 is a flow chart describing a discrete collection of supplier introduction process stages and associated tollgates;

FIG. 3 is a hierarchical matrix depicting one preferred collection of milestones and checklist items associated with a Global Section of stage 1 as set forth in FIG. 2;

FIG. 4 is a hierarchical matrix depicting one preferred collection of milestones and checklist items associated with a Global/Site Section of stage 1 as set forth in FIG. 2;

FIG. 5 is a hierarchical matrix depicting one preferred collection of milestones and checklist items associated with a Site MOC Section of stage 1 as set forth in FIG. 2;

FIG. 6 is a hierarchical matrix depicting one preferred collection of milestones and checklist items associated with a Global Section of stage 2 as set forth in FIG. 2;

FIG. 7 is a hierarchical matrix depicting one preferred collection of milestones and checklist items associated with a Global/Site Section of stage 2 as set forth in FIG. 2;

FIG. 8 is a hierarchical matrix depicting one preferred collection of milestones and checklist items associated with a Site MOC Section of stage 2 as set forth in FIG. 2;

FIG. 9 is a hierarchical matrix depicting one preferred collection of milestones and checklist items associated with a Global Section of stage 3 as set forth in FIG. 2;

FIG. 10 is a hierarchical matrix depicting one preferred collection of milestones and checklist items associated with a Global/Site Section of stage 3 as set forth in FIG. 2;

FIG. 11 is a hierarchical matrix depicting one preferred collection of milestones and checklist items associated with a Site MOC Section of stage 3 as set forth in FIG. 2;

FIG. 12 is a hierarchical matrix depicting one preferred collection of milestones and checklist items associated with a Global Section of stage 4 as set forth in FIG. 2;

FIG. 13 is a hierarchical matrix depicting one preferred collection of milestones and checklist items associated with a Site Section of stage 4 as set forth in FIG. 2;

FIG. 14 is a hierarchical matrix depicting one preferred collection of milestones and checklist items associated with a Global/Site Section of stage 5 as set forth in FIG. 2;

FIG. 15 is a hierarchical matrix depicting one preferred collection of milestones and checklist items associated with a Site MOC Section of stage 5 as set forth in FIG. 2; and

FIG. 16 is a hierarchical matrix depicting one preferred collection of milestones and checklist items associated with a Site MOC Section of stage 6 as set forth in FIG. 2.

### DETAILED DESCRIPTION OF THE INVENTION

The present invention is directed toward a comprehensive method and system for systematically introducing a new supplier into a product design and manufacturing system. Although not limited thereto, in one embodiment of the present invention, the system and method are implemented by an interactive computer software system incorporated within a computer-readable medium such as a hard disk drive, an optical medium such as a compact disk, or the like. Further, the medium is preferably available to a plurality of distributed users connected together over a computer network, such as a local area network (LAN), a wide area network (WAN), or the Internet. The inventive computer software system is designed to receive a plurality of supplier introduction information from a plurality of project participants. The application then facilitates the analysis, distribution, and implementation of this information.

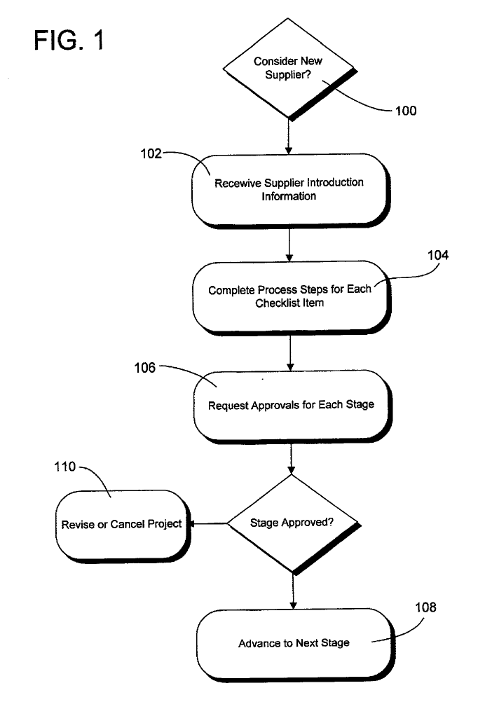

Referring to the Figures and, in particular, to FIG. 1, there is shown a flow chart describing a preferred general embodiment for introducing a new supplier into an organization. In a first step 100, an organization makes an initial determination as to whether or not a new supplier should be considered, either for an existing material or product, or a new material or product. This determination is typically made based upon such factors as cost savings, reduced risk, enhanced capacity, compliance with specifications, etc.

In step 102, information regarding the proposed introduction is generated, received, identified, and analyzed in accordance with the present invention. As described in additional detail below, step 200 involves progressing through a series stages relating to discrete components of the new supplier introduction process. In a preferred embodiment, each of the various process stages include a plurality of checklist elements and required milestones prior to stage completion. In step 104, process steps are completed for each required checklist item. Next, in step 106, approvals are requested for each stage of the project development process. If an approval for a particular stage is obtained, the status of that stage is changed to complete and the process is advanced into the next stage in step 108. However, if approval is not obtained, the status is not changed, and the project must be either revised or canceled in step 110.

By providing for a single comprehensive system for managing, facilitating, and monitoring the process of a supplier”s introduction, an organization is better able to ensure that proper precautions and efforts were taken in introducing the new supplier, thus substantially reducing risk and increasing transition. Further, an integrated system allows the disparate working environments of global organizations to better operate as an integrated unit. In particular, requiring the supplier introduction process to systematically progress through a system of stages, checklists and milestones as well as the required approvals at each stage substantially assists an organization”s ability to rapidly and accurately assess the best manner of introducing and implementing the selected supplier.

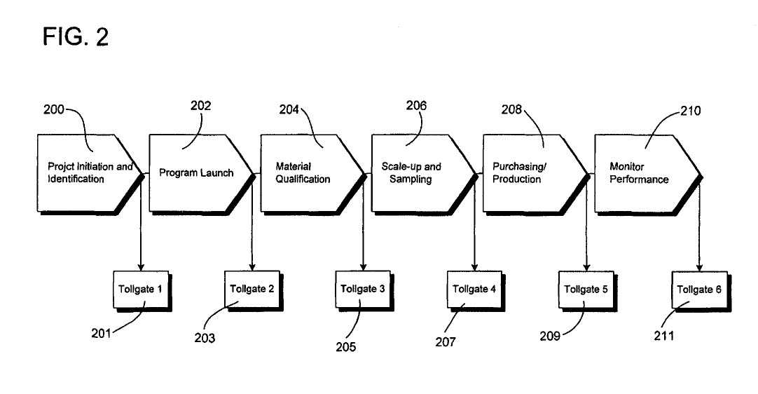

Referring now to FIG. 2, there is disclosed a flow chart describing a discrete collection of supplier introduction process stages and associated tollgates. In particular, a preferred embodiment of the present system includes six discrete stages specifically related to: 1) project identification (200); 2) program launch (202); 3) material qualification (204); 4) scale-up and sampling (206); 5) buy/production (208); and 6) monitor performance (210). Prior to advancing from one stage to the next, at least one approver must approve the advancement. It should be understood however, that although formal advancement from one stage to the next requires tollgate approval, information may be simultaneously obtained for multiple stages so as to expedite the overall introduction process. This approval process is generally referred to as a tollgate. Accordingly, for the above-described six stage embodiment, there are provided six discrete tollgates, 201, 203, 205, 207, 209 and 211, each of which must be passed before the project can advance to the next stage in its development.

As briefly alluded to above, in one embodiment of the present invention, the overall new supplier introduction process is implemented through a series of stages, actions, milestones, checklists, and tollgates. For each of the above stages 200, 202, 204, 206, 208 and 210, there are preferably provided a plurality of milestone items for each of a plurality of actors. Further, each of the various milestone items further includes a plurality of checklist items designed to meet the requirements of the milestone. As will be clearly understood from the description below, not all checklist items provided for a particular milestone will be applicable to every scenario. In these cases, completion of the item will not be required. However, once all of the required information has been gathered/received for each milestone in the stage, a stage tollgate is held, whereby a determination is made regarding whether the project will be advanced to the next stage. In one embodiment, the process for each stage is further broken down into three general sections, a Global section, a Global/Site section, and a Site Management of Change (MOC) section. These general sections identify the areas of focus and responsibility for the process steps included thereunder. That is, Global milestones and checklist items relate to determinations and processes that are non-site specific; Global/Site items relate to information based upon both the global organization”s requirements as well as the specific site being investigated; and Site MOC items relate to specific processes undertaken at the site-specific level. By classifying process steps into three general categories, the focus of each particular group of items is more easily identified.

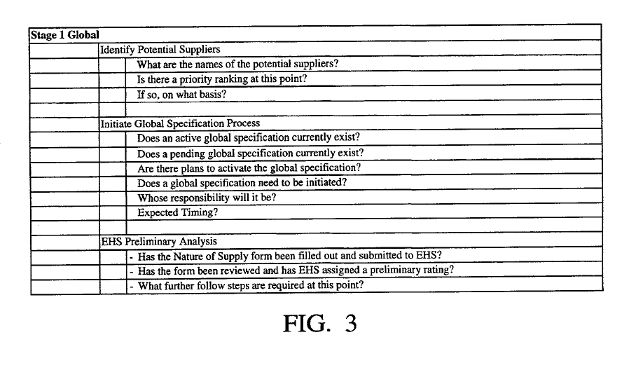

Referring now to FIG. 3, there is shown a hierarchical matrix depicting one preferred collection of milestones and checklist items associated with the Global Section of stage 1 (200) set forth above generally relating to project identification and inception. Milestone 300, the first milestone in the stage 1 Global process, relates to identifying potential suppliers for supplying a particular material or product. In a preferred embodiment, milestone 300 includes checklist items 302, 304, and 306 relating to: listing any identified potential suppliers (302), ranking the listing of suppliers based upon a variety of conditions such as history, size, reputation, etc. (304), and indicating the basis for the above ranking (306). Once a set of potential suppliers has been identified, a global specification process milestone 308 is initiated, whereby various required characteristics of the material are established and regulated.

In one embodiment, milestone 308 includes checklist items 310, 312, 314,316, 318, and 320 relating to: determining whether a global specification for the material/product is active (310), determining whether a global specification for the material/product is pending (312), plans to activate a global specification (314), plans to initiate a global specification (316), identifying the individual(s) responsible for the global specification (318); and defining an expected timeline for the global specification process (320).

In milestone 322, checklist items related to a preliminary environmental health and safety (EHS) analysis of the potential supplier(s) are completed. In one embodiment, milestone 322 includes checklist items 324, 326, and 328. Checklist item 324 relates to a determination of whether the EHS department has been provided with a description of the nature of the proposed supply arrangement (e.g., contract manufacturing, contract services, direct purchase, etc.). Checklist item 326 relates to a preliminary EHS rating assigned by the EHS department. Checklist item 328 relates to identifying any necessary follow up steps based upon the initial EHS rating, and the type of material/product being supplied.

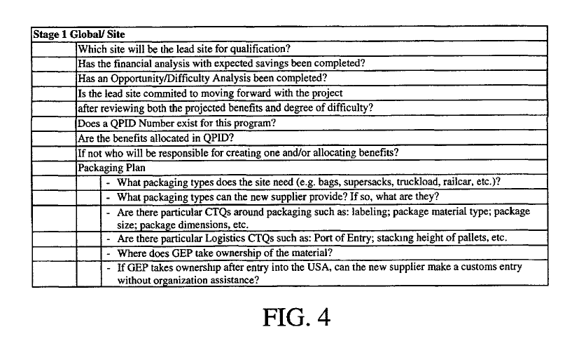

Referring now to FIG. 4, there is shown a hierarchical matrix depicting one preferred collection of milestones and checklist items associated with the Global/Site Section of stage 1 (200). A first milestone 400 is provided relating to an identification of a lead site for qualification purposes. Milestone 402 relates to determining whether a financial analysis has been completed for the project. Milestone 404 identifies whether a opportunity/difficulty analysis has been completed. Milestone 406 relates to an indication on the part of the lead site as to whether they wish to continue with the project in view of the opportunity/difficulty analysis. In milestone 408, an indication is received relating to whether a QPID (Quality Process Improvement Database) number has been assigned to the project. The QPID is a database which tracks projects and the productivity savings those projects generate. Milestone 410 relates to determining whether project benefits have been allocated in QPID. If such benefits have not been allocated, related milestone 412, identifies the individual(s) responsible for doing so.

Milestone 414 relates to a proposed packing plan to be implemented in shipping the supplied material/products. Preferably, this milestone includes checklist items 416, 418, 420, 422, and 424 for indicating the various components of the plan. Checklist item 416 relates to identifying the site specific packaging types, (e.g. bags, supersacks, truckload, railcar, etc.). Checklist item 418 relates to the packaging types available from the new supplier. Checklist item 420 relates to identifying particular requirements regarding the packaging and shipping process such as, e.g., labeling, package material type, package size, package dimensions, etc.. Such requirements are generally referred to as CTQ”s or Criticals to Quality. Checklist item 422 relates to identifying particular logistics CTQs such as e.g., port of entry, stacking height of pallets, etc. Checklist item 424 relates to determining where the organization legally takes ownership of the material/product. And, if ownership transfer occurs within the U.S., a determination is received regarding whether the new supplier is able to make a customs entry without the assistance of the organization.

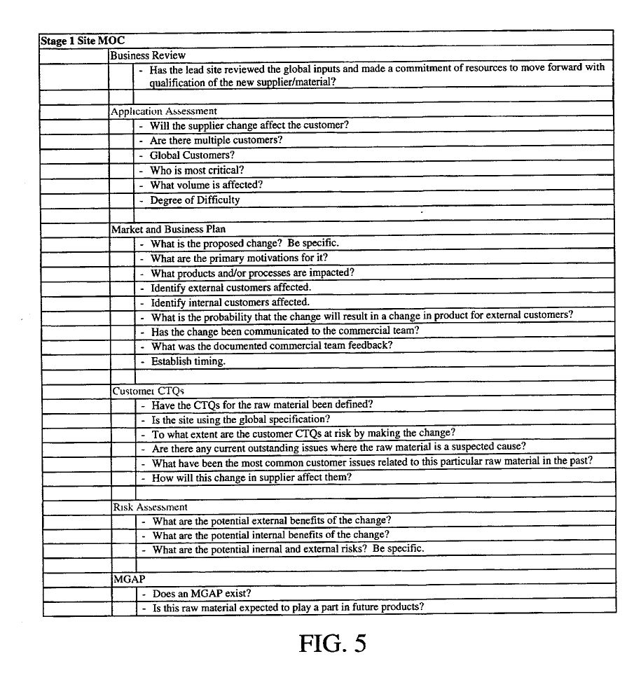

Referring now to FIG. 5, there is shown a hierarchical matrix depicting one preferred collection of milestones and checklist items associated with the Site MOC Section of stage 1 (200). A first milestone 500 is provided relating to the results of business review for the lead site. In one preferred embodiment, milestone 502 includes a checklist item 504 relating to lead site”s commitment to making necessary resources available. Milestone 506 relates to a application assessment regarding the effect of supply changes on customers. In particular, a preferred milestone 506 includes checklist items 508, 510, 512, 514, and 516. Checklist item 508 relates to determining the proposed supplier change”s effect on customers. Checklist item 510 relates to the number of customers effected. Checklist item 512 identifies the most critical of the effected customers. Checklist item 514 identifies the volume of business effected. Checklist item 516 relates to the project”s degree of difficulty, low, medium, or high.

A milestone 518 is provided relating generally to a marketing and business plan for the proposed supplier change. In a preferred embodiment, milestone 518 includes checklist items 520, 522, 524, 526, 528, 530, 532, 534, and 536. Checklist item 520 relates particularly to an specific definition of the proposed change (i.e., what material/product is to be changed for what locations and who are the current and proposed suppliers). Checklist item 522 relates to identifying the primary motivations for the change (e.g., cost, quality, etc.). Checklist item 524 identifies the products and/or processes are impacted by the change. Checklist item 526 identifies the external customers affected by the change. Checklist item 528 identifies the internal customers affected by the change. Checklist item 530 details the probability that the change will result in a change in product for external customers. Checklist item 532 indicates whether the proposed change has been communicated to the commercial team. Related checklist item 534 relates to any documented feedback received from the commercial team. Checklist item 536 relates to the timing established for the proposed change.

Once the business and marketing plan regarding the proposed supplier change is generated, specific information regarding the various technical needs (i.e., CTQ”s) of the customers are established in milestone 538. In a preferred embodiment, milestone 538 includes checklists items 540, 542, 544, 546, 548, and 550. Checklist item 540 determines whether the specific customer CTQ”s relating to the changed raw material have been defined. In checklist item 542, it is determined whether the lead site is currently using the global specification described above to produce the material. Checklist item 544 identifies the potential risk the proposed change has on customer CTQs. In checklist item 542, any current outstanding issues where the raw material is a suspected cause are identified. The most common customer issues related to the particular raw material are identified in checklist item 544. An indication as to how the proposed change in supplier with effect the customers is made in checklist item 546.

Milestone 548 relates specifically to a more detailed risk assessment of the affects of the change is made to explore the potential external and internal risks and benefits of the change. Checklist items 550, 552, and 554 relate to identifying external benefits, internal benefits, and potential risks, respectively. Milestone 556 is related generally to a multi-generational application plan (MGAP) wherein the prospective phases of the new supplier introduction are disclosed and detailed. Preferably, milestone 556 includes checklist items 558 and 560 relating to the existence of an MGAP and the potential future uses for the material in other products, respectively.

After all of the information requested in FIGS. 3-5 has been generated and/or received, a stage 1 tollgate 201 is conducted. Typically, a stage tollgate includes analysis by various individuals charged with the responsibility of evaluating whether the proposed supplier introduction is worth pursuing at that time, with the information currently collected. In a preferred embodiment, tollgate participants for stage 1 include representatives from each of the following departments: material/product sourcing, EHS, Technology, Manufacturing, Quality, TCO (Total Cost Out related to determining the total cost impact of the supplier change), Finance, and Product Management. By obtaining approval from each of these representatives, the organization can be sure of address all concerns prior to proceeding with the introduction. If it is determined that the supplier change is not suitable for immediate development, tollgate 1 is not passed and the project is either reworked or canceled. However, if it is determined that the introduction is suitable for development, the stage 1 tollgate is passed and the process proceeds to stage 2, more fully set forth below.

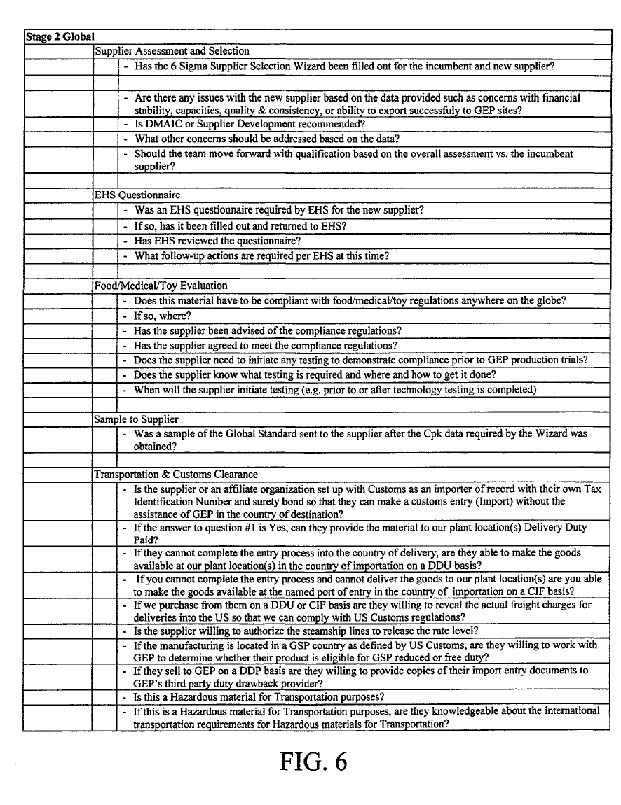

Referring now to FIG. 6, there is shown a hierarchical matrix depicting one preferred collection of milestones and checklist items associated with the Global Section of stage 2 (202) set forth above generally relating to program launch. Milestone 600, the first milestone in the stage 2 Global process, relates generally to supplier assessment and selection and includes a thorough evaluation of the proposed supplier”s ability to meet the needs of the organization on multiple levels including, available capacity, EHS conditions, and quality of material. A preferred embodiment of milestone 600 includes a plurality of checklist items 602, 604, 606, and 608. Checklist item 602 relates to a determination as to whether a supplier selection analysis has been conducted for both the incumbent supplier and the proposed supplier. In one preferred embodiment, such an analysis may be conducted through the use of an interactive computer software application, such as that described in co-pending application Ser. No. 09/614,728, filed Jul. 12, 2000, the disclosure of which is incorporated herein by reference.

Checklist item 604 relates to identifying issues about the new supplier based on the data provided, such as concerns with financial stability, capacities, quality & consistency, or ability to export successfully to organization sites. In checklist 606, a determination is made regarding whether DMAIC or Supplier Development is recommended. DMAIC refers to the following process control steps: Define, Measure, Analysis, Improve, and Control, whereas Supplier Development may be required in additional solutions are required to product the necessary material. Checklist 608 relates to a determination as to whether the team should move forward with qualification based on the overall assessment of the new supplier vs. the incumbent supplier.

Milestone 610 relates generally to results received in an EHS questionnaire completed by the proposed supplier, indicating the proposed supplier”s perceived position on key environmental health and safety elements. Preferably, milestone 610 includes checklist items 612, 614, 616, and 618 related to the questionnaire. Checklist item 612 relates to a determination as to whether an EHS questionnaire was required by EHS for the new supplier. If so, in checklist item 614, it is determined whether the questionnaire was returned to EHS. In checklist 616, it is determined whether EHS has reviewed the questionnaire. Once reviewed, any follow-up actions required by EHS at this time are identified in checklist item 618.

Milestone 620 relates generally to an evaluation of the material and proposed supplier from a food/medical/toy regulatory perspective. A preferred embodiment of milestone 620 includes checklist items 622, 624, 626, 628, 630, 632, and 634. Checklist item 622 relates to a determination as to whether the material has to be compliant with food/medical/toy regulations anywhere on the globe. If so, checklist item 624 identifies where such regulations exist. Checklist item 626 relates to whether the supplier has been advised of the compliance regulations. Checklist item 628 indicates whether the supplier has agreed to meet the applicable compliance regulations. In checklist item 630, it is determined whether the supplier needs to initiate any testing to demonstrate compliance prior to actual production trials. In checklist item 632, it is determined whether the supplier knows what testing is required and where and how to get it done. The timing of this testing is identified in checklist item 634.

The next milestone 636 relates generally to a product sample sent to the proposed supplier. In associated checklist item 638, it is determined whether a sample of the material meeting the organization”s standard was delivered to the supplier. Milestone 640 relates generally to a transportation and customs clearance investigation. Such an investigation is made to determine whether the proposed supplier is authorized with the relevant customs agency as an importer of record. Preferably, this milestone includes several checklist items to ensure that all necessary information has been obtained and reviewed.

Checklist item 642 is related to determining whether the potential supplier (or an affiliate organization) is set up with Customs as an importer of record with their own Tax Identification Number and surety bond so that they can make a customs entry (Import) without the assistance of the organization in the country of destination. If the proposed supplier is an importer of record, checklist item 644 is completed, wherein it is determined whether the proposed supplier can provide the material to the organization”s plant location(s) Delivery Duty Paid (DDP). However, if the proposed supplier is not an importer of record, checklist item 646 is completed, where it is determined whether the supplier is able to make the goods available at the organization”s plant location(s) in the country of importation on a Delivery Duty Unpaid (DDU) basis.

If the supplier cannot complete the entry process and cannot deliver the goods to the organization”s plant location(s), checklist item 648 is completed where it is determined whether the supplier is able to make the goods available at the named port of entry in the country of importation on a Cost, Insurance, and Freight (CIF) basis. In checklist item 650, it is determined whether, for DDU and CIF based purchases, the supplier is willing to reveal the actual freight charges for deliveries into the U.S. In checklist item 652, it is determined whether the supplier is willing to authorize the steamship lines to release the rate level to the organization. For manufacturing facilities located in a GSP country as defined by US Customs, checklist item 654 relates to determining whether the material/product is eligible for GSP reduced or free duty. GSP (Generalized System of Preferences) refers to a list countries with whom trade is encouraged by the US government. Countries on the GSP list are afforded certain types of tariff relief. Checklist item 656 relates to determining, for DDP based purchases, whether the supplier is willing to provide copies of their import entry documents to a third party duty drawback provider affiliated with the organization.

In checklist item 658, it is determined whether the material to be supplied is to be considered a hazardous material for transportation purposes. If so, checklist item 660 relates to determining whether the supplier is knowledgeable about the international transportation requirements for such hazardous materials.

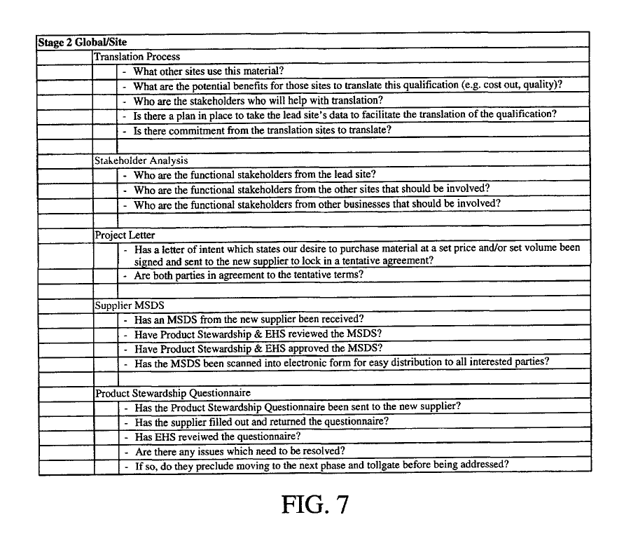

Referring now to FIG. 7, there is shown a hierarchical matrix depicting one preferred collection of milestones and checklist items associated with the Global/Site Section of stage 2. A first milestone 700 is provided relating a process for translating the a material specification to one location from another. Preferably, milestone 700 includes checklist items 702, 704, 706, 708, and 710. Checklist item 702 identifies any other sites which use the material. Checklist item 704 identifies the potential benefits for those sites to translate the present qualification (e.g. cost out, quality). Checklist 706 identifies the stakeholders (those individuals whose business is affected by the transition) who will help with translation. Checklist 708 indicates whether a plan is in place to take the lead site”s data to facilitate the translation of the qualification. Checklist 710 indicates whether or not there is commitment from the translation sites to translate the qualification.

An analysis of the stakeholders is reviewed in milestone 712. Preferably, milestone 712 includes a plurality of checklist items designed to indicate the results of the analysis. Checklist item 714 identifies the functional stakeholders from the lead site. Checklist item 716 identifies the functional stakeholders from the other sites that should be involved. Checklist item 718 identifies the functional stakeholders from other businesses that should be involved.

Milestone 720 relates generally to a project letter sent by the organization to the proposed supplier. Checklist item 722 indicates whether a letter of intent which states the organization”s desire to purchase material at a set price and/or set volume been signed and sent to the new supplier to lock in a tentative agreement. Checklist item 724 indicates whether both parties are in agreement to the tentative terms.

Milestone 726 relates generally to the material safety data sheets (MSDS”s) for the proposed material. Preferably, checklist item 728 indicates whether the MSDS”s have been received. Checklist item 730 indicates whether the MDSD”s have been reviewed by product stewardship and EHS. Checklist item 732 indicates whether the MDSD”s have been approved by product stewardship and EHS. Checklist item 734 indicates whether or not the sheets have been converted into electronic form for facilitating dissemination to interested parties.

In milestone 736, checklist items related to a completed product stewardship questionnaire are completed. In particular, checklist item 738 indicates whether the questionnaire has been sent to the new supplier. If so, checklist item 740 indicates whether the supplier has filled out and returned the questionnaire. Checklist item 742 indicates whether EHS has reviewed the completed questionnaire. Checklist item 744 identifies any issues which need to be resolved. If so, checklist item 746 indicates whether the issues preclude moving to the next phase and tollgate before being addressed.

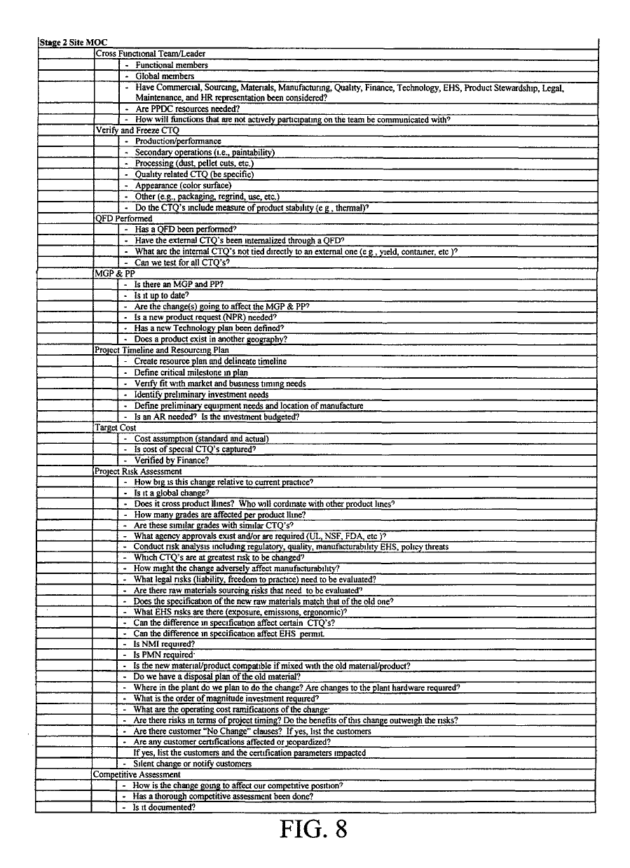

Referring now to FIG. 8, there is shown a hierarchical matrix depicting one preferred collection of milestones and checklist items associated with the Site MOC Section of stage 2 set forth above. Milestone 800 relates generally to the establishment of a cross-functional team of individuals comprised of individuals from various business functions. The cross-functional team functions to ensure that each proposed modification is reviewed from a risk standpoint for each represented function (e.g., technology, manufacturing, finance, EHS, legal, product stewardship, etc.) In a preferred embodiment, milestone 800 includes several checklist item for indicating the composition and decisions relating to the team. In particular, checklist item 801 identifies the functional team members. The global team members are identified in checklist item 802. Checklist item 803 indicates whether representatives from the following groups/departments had been considered in putting together the team: Commercial, Sourcing, Materials, Manufacturing, Quality, Finance, Technology, EHS, Product Stewardship, Legal, Maintenance, and HR. Checklist item 804 indicates whether Polymer Process and Development Center (PPDC) resources are necessary. Checklist item 805, identifies how groups that are not actively participating on the team will be communicated with.

Milestone 806 relates generally to validating and freezing the various customer CTQ”s identified in stage 1, above. In a preferred embodiment, various checklist items are included with milestone 806 for identifying the final CTQ”s for certain categories.

Checklist item 808 identifies the final poduction/performance CTQ”s. Checklist item 809 identifies the final secondary operations CTQ”s (e.g., paintability). Checklist item 810 identifies the final processing CTQ”s (e.g., dust, pellet cuts , etc.). Checklist item 811 identifies the final quality related CTQs. Checklist item 812 identifies the final appearance CTQ”s (e.g., color surface). Checklist item 813 identifies any other customer CTQ”s (e.g., packaging, regrind, use, etc.). Checklist item 814 indicates whether the CTQ”s include a measure of product stability (e.g., thermal stablility).

The results of a Quality Functional Deployment analysis (QFD) are detailed in milestone 815. Preferably, various checklist items are included for prioritizing and ranking the identified CTQ”s. Checklist item 816 indicates whether a QFD has been performed. Checklist item 817 indicates whether external CTQ”s have been internalized through a QFD. Checklist item 818 identifies the internal CTQ”s which are not tied directly to an external one (e.g., yield, container, etc.). In checklist item 819, it is determined whether additional testing can be completed for all CTQ”s.

Milestone 820 relates generally to establishing and developing both a MGAP and a MGPP (Multi-Generation Application Plan and Multi-Generation Product Plan). Checklist item 821, indicates whether the MGAP and the MGPP exist. In checklist item 822, it is indicated whether the MGAP and MGPP are up to date. Checklist item 823 indicates whether the proposed supplier change is going to affect the MGAP & MGPP. Checklist item 824 indicates whether a new product request (NPR) is required. Checklist item 825 indicates whether a new technology plan has been defined. Checklist 826 item indicates whether an affected product exists in another location (e.g., Europe, Pacific Rim, etc.).

Milestone 827 relates generally to the expected timing of the supplier introduction process. Preferably a plurality of checklist items are included which enable information relating to such timing to be received. In particular, checklist item 828 defines a resource plan and associated timeline. Checklist item 829 indicates whether a resource plan and associated timeline have been created. In checklist item 830, the critical milestones in the plan are defined. In checklist 831, resource timing is verified to fit with market and business timing needs. Checklist item 832 identifies preliminary investment needs. Checklist item 833 defines the preliminary equipment needs and location of manufacture. Checklist item 834 indicates whether an appropriation request is necessary for any required capital investments, and if the investment has been budgeted by the organization.

Milestone 835 relates generally to determining the target cost for the project. In a preferred embodiment, checklist item 836 identifies both the standard and actual cost assumptions. This refers to determinations relating to the cost of relevant materials. Checklist item 837 indicates whether the cost of special CTQ”s has been captured. Checklist item 838 indicates whether the cost projections have been verified by the finance department.

Milestone 839 relates to a detailed project risk assessment. Preferably, a collection of related checklist items are provided wherein information regarding the risk assessment is described for review. In checklist item 840 a determination is made regarding the degree of change from the practices relating to the current supplier. In checklist item 841, it is determined whether the change in supplier is a global change or simply a site change. In checklist item 842, a determination is made as to whether the supplier change extends across multiple product lines and, if so, who is responsible for coordination between the various product lines. In checklist item 843, it is determined how many grades are affected per product line. In checklist item 844, it is determined whether the various grades are similar, with similar CTQ”s.

Often in manufacturing industries, approvals from governmental agencies such as UL, NSF, FDA, etc. are often required prior to proceeding with a project. In checklist item 845, a determination is made as to whether such agency approvals either exist or are required. Checklist item 846 identifies whether a risk analysis has been completed which included a regulatory evaluation, a quality evaluation, a manufacturability evaluation, an EHS evaluation and a policy threats evaluation. In response to this analysis, the CTQ”s which are at the greatest risk of modification are identified. In checklist item 847, the affect of these possible changes on manufacturability is identified.

In checklist item 848, the possible legal risks are identified (e.g., liability, freedom to practice, etc.). In checklist item 849, it is determined whether raw materials sourcing risks exists which need to be evaluated. In checklist item 850, a determination is made as to whether the new specification for the new raw material matches that of any presently implemented specification. In checklist item 851, any EHS risks associated with the proposed supplier are positively identified (e.g., exposure, emissions, ergonomic). In checklist item 852, it is determined whether the difference in the current and proposed specifications affect customer CTQ”s. Further, it is determined in checklist item 853 whether the difference in specification affects any necessary EHS permits.

In checklist item 854 it is determined whether a new material introduction (NMI) process is required to initiate and qualify a new material to the organization. In checklist item 855 it is determined whether a Pre-Manufacturing Notice (PMN) is required so as to inform Manufacturing about the upcoming change, thereby ensuring that all necessary procedures are followed. In checklist item 856 it is determined whether the new material/product is compatible if mixed with the old material/product. In other words, can present material/product inventory be mixed with new material/product, or must they be used independently? If old material disposal is required prior to new material use, in checklist item 857, it is determined whether a disposal plan for the old material has been formulated.

In checklist item 858, determinations are made regarding site changes resulting from the supplier change. In particular, such determinations include determining the location of any changes within the plant and determining if hardware changes are. In checklist item 859, the order of magnitude any required investment is determined. In checklist item 860, any operating cost ramifications of the change are identified and defined. In checklist item 861, project timing risks are identified. In checklist item 862, an risk/benefit analysis relating the change is completed. In checklist item 863, it is determined whether any customers have No Change clauses in their agreements with the organization. If so, such customers are identified in checklist item 864. In checklist item 865, it is determined whether any customer certifications will be affected or jeopardized by the change in suppliers. If so, such affected customers and the certification parameters impacted are identified in checklist item 866. In checklist item 867, it is determined whether to affect the change silently or whether to notify customers regarding the change.

The results of a competition analysis is detailed in milestone 868. In particular, related checklist item 869 defines how the change will likely affect the organization”s competitive position. In checklist item 870 it is determined whether a thorough competitive assessment has been done. If so, checklist item 871 indicates whether the assessment has been documented.

After all of the information requested in FIGS. 6-8 has been generated and/or received, a stage 2 tollgate 203 is conducted. As set forth above regarding stage 1, the stage tollgate typically includes analysis by various individuals charged with the responsibility of evaluating whether the proposed supplier introduction is worth pursuing at that time, with the information currently collected. In a preferred embodiment, tollgate participants for stage 2 include representatives from each of the following departments: material/product sourcing, EHS, Technology, Manufacturing, Finance, and Product Stewardship. By obtaining approval from each of these representatives, the organization can be sure of address all concerns prior to proceeding with the introduction. If it is determined that the supplier change is not suitable for immediate development, tollgate 2 is not passed and the project is either reworked or canceled. However, if it is determined that the introduction is suitable for development, the stage 2 tollgate is passed and the process proceeds to stage 3, more fully set forth below.

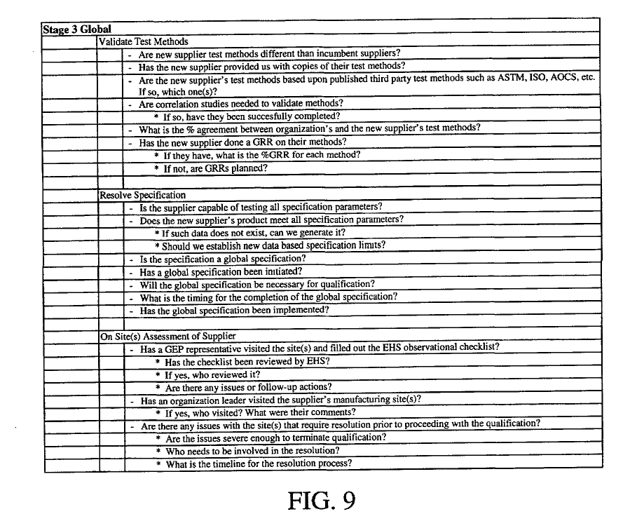

Referring now to FIG. 9, there is shown a hierarchical matrix depicting one preferred collection of milestones and checklist items associated with the Global Section of stage 3 (204) set forth above generally relating to material qualification.

Milestone 900, the first milestone in the stage 3 Global process, relates generally to a process of validating the various testing methods utilized in qualifying the material to be supplied. A preferred embodiment of milestone 900 includes a plurality of checklist items designed to receive information related to the test methods. Checklist item 902indicates whether the proposed supplier”s test methods are different than incumbent supplier”s methods. In checklist item 904,it is indicated whether or not the new supplier has provided the organization with copies of their test methods.

Checklist item 906 indicates whether the new supplier”s test methods are based upon published third party test methods such as ASTM, ISO, AOCS, etc. and if so, which one (s).

Checklist item 904 indicates whether correlation studies are necessary in order to validate the new supplier”s methods. If such studies were determined to be necessary, checklist item 906 indicates whether such studies have been successfully completed. Checklist item 908 identifies the percentage agreement between the organization”s and the new supplier”s test methods. In checklist item 91 0, it is determined whether the new supplier has completed a Gage Repeatability and Reproducibility (GRR) analysis used to determine the accruacy of the relevant measuring system. %GRR is a measure of how much of the specification range the measurement error takes up. If so, checklist item 912 indicates the percentage GRR for each method. If a GRR has not been completed for the methods, checklist item 914 indicates whether any GRR”s are planned.

Milestone 916 is related to efforts made to resolve the applied specification. Preferably, a plurality of checklist items receive indications or information relating to the specification resolution process. In checklist item 918, it is determined whether the new supplier is capable of testing all specification parameters. Checklist item 920 indicates whether the new supplier”s product meets all specification parameters. If all specification parameters are not met, checklist item 922, indicates whether data exists to substantiate current specification limits. If such data does not exist, checklist item 924 indicates whether it can be generated. Checklist item 926 indicates whether new data based specification limits should be established.

Checklist item 928 relates to determining whether the applied specification is a global specification. If not, it is indicated in checklist item 930 if a global specification has been initiated. In checklist item 932, it is indicated whether or not the global specification will be necessary for qualification. Checklist item 934 indicates the timing for the completion of the global specification. If a global specification has been initiated and created, checklist item 936 indicates whether the global specification been implemented.

Milestone 938 relates generally to an on site assessment of the supplier. In checklist item 940, it is determined whether an organization representative has visited the site(s) and filled out an EHS observational checklist. If so, checklist item 942 indicates whether the checklist has been reviewed by the EHS department. If so, checklist item 944 identifies who in EHS reviewed the observational checklist. In checklist item 946, any issues or follow-up actions are identifies and defined.

Checklist item 948 indicates whether an organization leader has visited the supplier”s manufacturing site(s). If so, the visiting leader is identified and their comments are noted in checklist item 950. Any issues with the site(s) that require resolution prior to proceeding with the qualification are identified in checklist item 952. Checklist item 954 indicates whether any of the identifies issues are severe enough to terminate the qualification process. Checklist item 956 identifies the individuals needed to be involved in the resolution. Further, checklist item 958 identifies a proposed timeline for the issue resolution process.

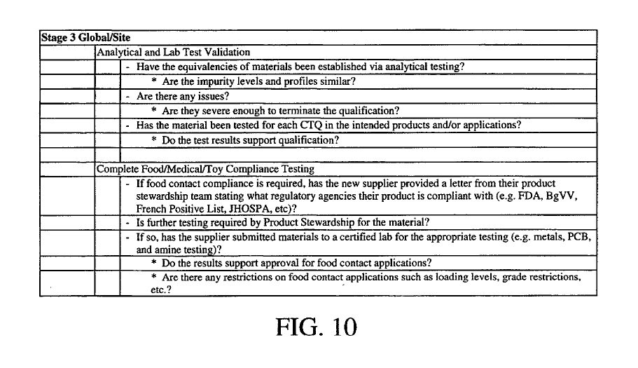

Referring now to FIG. 10, there is shown a hierarchical matrix depicting one referred collection of milestones and checklist items associated with the Global/Site Section of stage 3. A first milestone 1000 is provided generally relating to the validation of the analytical and laboratory testing that will be completed by the proposed supplier. Preferably, a plurality of checklist items are included under milestone 1000 for receiving information related to this validation. In particular, checklist item 1002 indicates whether the equivalencies of both the current and proposed materials have been established via analytical testing. Checklist item 1004 identifies whether the impurity levels and profiles of the two materials are similar. Checklist item 1006 identifies any issues related to the equivalence. Checklist item 1008 indicates whether any issues severe enough to terminate the qualification process. Further, checklist item 1010 indicates whether the material has been tested for each CTQ in the intended products and specifications. Checklist item 1012 indicates whether the test results support qualification of the material.

Milestone 1014 relates to the Food/Medical/Toy compliance testing referenced above. In checklist item 1016, it is indicated whether food contact compliance is required, and whether the new supplier has provided a letter from their product stewardship team stating what regulatory agencies their product is compliant with various food contact regulators (e.g. FDA, BgVV, French Positive List, JHOSPA, etc). Any further testing required by Product Stewardship for the material is identified in checklist item 1018. Further, checklist item 1020 indicates whether the required materials have been submitted to a certified lab for the appropriate testing (e.g. metals, PCB, and amine testing). Checklist item 1022 indicates whether the results of such testing support approval for food contact applications. Checklist item 1024 identifies any restrictions that have been placed on food contact applications such as loading levels, grade restrictions, etc.

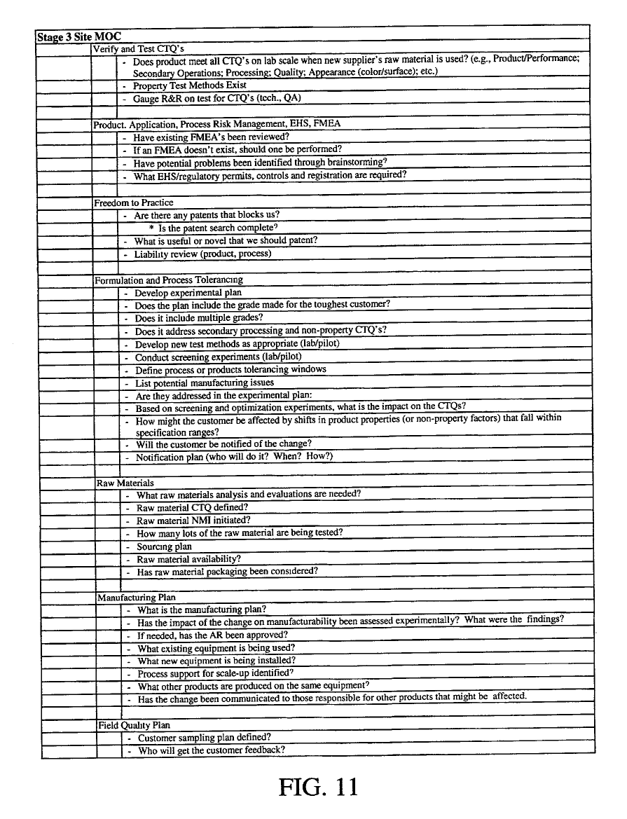

Referring now to FIG. 11, there is shown a hierarchical matrix depicting one preferred collection of milestones and checklist items associated with the Site MOC Section of stage 3 set forth above. Milestone 1100 relates generally to the verification and testing of the customer CTQ”s identified and frozen in stages 1 and 2 above. Related checklist items are provided for receiving information related to such verification. Checklist item 1102 indicates whether the end product meets all CTQ”s on a laboratory scale when new supplier”s raw material is used (e.g., those related to product/performance, secondary operations, processing, quality, appearance, etc.). Checklist item 1104 indicates whether property test methods exist for testing the CTQ”s. The gauge R&R results for each CTQ test are identified in checklist item 1106.

Milestone 1108 relates generally to a Failure Modes and Effects Analysis (FMEA) used to proactively identify and address all possible failure modes for a particular part, process, product, etc. as well as the potential causes and effects of the failures.

Checklist item 1110 indicates whether existing FMEA”s have been reviewed. If an FMEA doesn”t exist, checklist item 1112 indicates whether a new one should be performed. Potential problems related to the FMEA are identified in checklist item 1114. Any required EHS/regulatory permits, controls and registrations are identified in checklist item 1116.

Milestone 1118 relates generally to a freedom to practice investigation performed for the proposed material or process. In particular, checklist item 1120 indicates whether any patents have been found which block the use of the material or process. Checklist item 1122 indicates whether a patent search has been completed. Checklist item 1124 identifies any useful or novel features of the material or process for which patent protection may be sought. The results of a liability review related to the product and process indicated in checklist item 1126.

Milestone 1128 relates generally to a formulation and process tolerancing analysis. In particular, checklist item 1130 identifies an experimental tolerancing plan. In checklist item 1132, it is indicated whether the plan includes the grade made for the toughest customer. Whether the plan includes multiple grades is indicated in checklist item 1134. Further, whether the plan addresses secondary processing and non-property CTQ”s is indicated in checklist item 1136. Any newly developed test methods (e.g., lab/pilot) are identified in checklist item 1138. Whether screening experiments (e.g., lab/pilot) have been conducted is indicated in checklist item 1140. Any identified process or products tolerancing windows are set forth in checklist item 1142. Further, any potential manufacturing issues are identified in checklist item 1144. Whether such issues are addressedthe experimental plan is indicated in checklist item 1146. The impact on the CTQ”s of the identified issues based on screening and optimization experiments is indicated in checklist item 1148. Checklist item 1150 indicates how customer”s might be affected by shifts in product properties (or non-property factors) that fall within specification ranges. Whether the customer will be notified of the change is indicated in checklist item 1152. If so, the notification plan (i.e., who will do it?; when?; how?) is set forth in checklist item 1154.

Milestone 1156 relates generally to an analysis of the raw materials to be produced. In particular, checklist item 1158 identifies what raw materials analysis and evaluations are necessary. Checklist item 1160 defines the raw material CTQ. Checklist item 1168 indicates whether a new material introduction process for the raw material has been initiated. The number of lots of the raw material being tested is identified in checklist item 1170. The sourcing plan for the raw materials is defined in checklist item 1172. Further, the availability of the raw material is outline in checklist item 1174. Whether raw material packaging has been considered is indicated in checklist item 1176.

Milestone 1178 relates generally to the manufacturing plan for the products which are produced using the material. In checklist item 1180, this plan is defined. Checklist item 1182 identifies the potential impact of the supply change on manufacturability. Checklist item 1184 indicates whether any necessary AR has been approved. The existing equipment which is being used is identified in checklist item 1186. Any new equipment which is being installed is identified in checklist item 1188. Further, process support for the scale-up is identified in checklist item 1190. Any other products which are produced on the same equipment are identified in checklist item 1192. For these other products, whether the equipment change has been communicated to those responsible for other products that might be affected is indicated in checklist item 1194.

Milestone 1196 relates generally to a field quality plan for testing the quality of the scaled-up product. A field quality plan is used to monitor the effects of any changes on the customers and to address any issues which may arise. In particular, checklist item 1198 defines a customer sampling plan related to the scaled-up product. The departments or individuals tasked with receiving the customer feedback are identified in checklist item 1199.

After all of the information requested in FIGS. 9-11 has been generated and/or received, a stage 3 tollgate 205 is conducted. As set forth above regarding stages 1 and 2, the stage tollgate typically includes analysis by various individuals charged with the responsibility of evaluating whether the proposed supplier introduction is worth pursuing at that time, with the information currently collected. In a preferred embodiment, tollgate participants for stage 3 include representatives from each of the following departments: material/product sourcing, EHS, Technology, Manufacturing, Quality, and Product Stewardship. By obtaining approval from each of these representatives, the organization can be sure of address all concerns prior to proceeding with the introduction. If it is determined that the supplier change is not suitable for further scale-up and customer testing, tollgate 3 is not passed and the project is either reworked in stages 1-3 or canceled. However, if it is determined that the introduction is suitable for scale-up and testing, the stage 3 tollgate is passed and the process proceeds to stage 4, more fully set forth below.

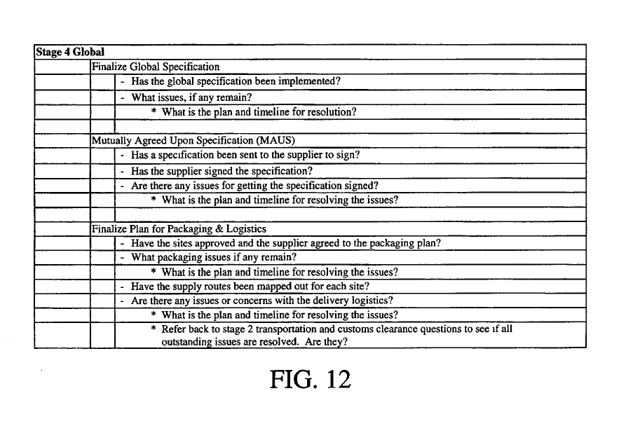

Referring now to FIG. 12, there is shown a hierarchical matrix depicting one preferred collection of milestones and checklist items associated with the Global Section of stage 4 (206) set forth above generally relating to product scale-up and customer testing. Milestone 1200, the first milestone in the stage 4 Global process, relates generally to finalizing the global specification initiated in stage 1. Initially, in checklist item 1202, a determination is made as to whether the global specification has been implemented. Any remaining issues with the specification are identified in checklist item 1204. Further, for such remaining issues, the plan and timeline for resolution is defined in checklist item 1206.

Milestone 1208 relates to a final specification used in producing the material for purchase. This specification may be referred to as the Mutually Agreed Upon Specification (MAUS). In checklist item 1210, it is determined whether such as MAUS has been delivered to the supplier for execution. Checklist item 1212 indicates whether the MAUS was signed. Any issues relating to obtaining the signature are identified in checklist item 1214. Further, the plan and timeline for resolving the issues are set forth in checklist item 1216.

Milestone 1218 relates generally to finalizing the plan for packaging & logistics initially defined in stage 1. In particular, checklist item 1220 indicates whether the sites have approved and the supplier agreed to the packaging plan. Any remaining packaging issues are identified in checklist item 1222. Further, the plan and timeline for resolving the issues is defined in checklist item 1224. Checklist item 1226 indicates whether the supply routes have been mapped out for each site.

Any known issues or concerns relating to the delivery logistics are identified in checklist item 1228. For any issues, a plan and timeline for resolving the issues is set forth in checklist item 1230. Any other customs-related issues or concerns are identified in checklist item 1232. In checklist item 1234, a plan and timeline for resolving any identified issues is established. Checklist item 1236 relates to the transportation and customs clearance of stage 2 and indicates whether any outstanding issues have been resolved.

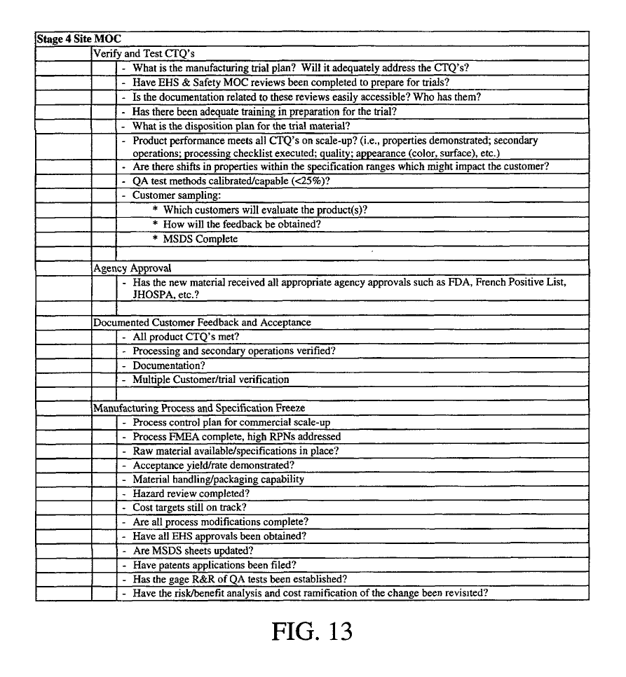

Referring now to FIG. 13, there is shown a hierarchical matrix depicting one preferred collection of milestones and checklist items associated with the Site MOC Section of stage 4 set forth above. Milestone 1300 relates generally to the further verification and testing of the CTQ”s, and in particular the CTQ”s affected by manufacturing processes. Checklist item 1302 defines a manufacturing trial plan and whether the plan will adequately addressCTQ”s. Checklist item 1304 indicates whether EHS & Safety MOC reviews have been completed to prepare for manufacturing trials. Checklist item 1306 indicates whether the documentation related to these reviews is easily accessiblewho is in possession of the documentation. Checklist item 1308 indicates whether there has been adequate training in preparation for the trial. A disposition plan for the trial material is identified and defined in checklist item 1310.

An indication as to whether the product performance met all of the various CTQ”s on scale-up is indicated in checklist item 1312 (i.e., properties demonstrated, secondary operations, processing checklist executed, quality, appearance (color, surface), etc.). In checklist item 1314, any shifts in properties within the specification ranges are identified which might impact the customer. In checklist item 1316, QA test methods calibrated/capable (<25%) to ensure proper accuracy of the test methods and results. Relating to customer review of the sample products, checklist item 1318 identifies which customers will evaluate the product(s). Checklist item 1320 indicates how the customer feedback will be obtained. Further, checklist item 1322, indicates whether the material MSDS is complete.

Milestone 1324 relates generally to obtaining the final Agency approvals identified in stage 2 above. In particular, checklist item 1326 indicates whether the new material has received all appropriate agency approvals such as FDA, French Positive List, JHOSPA, etc. Milestone 1328 relates to documented customer feedback and scale-up product acceptance. In particular, checklist item 1330 indicates whether all product CTQ”s have been met by the sample product. Checklist item 1332 indicates whether the processing and secondary operations required for the product have been verified by the customer. Any customer documentation is identified in checklist item 1334. Further, information relating to multiple customer/multiple trial verification is referenced in checklist item 1336.

Milestone 1338 relates generally to freezing the established manufacturing process and final specification. In particular, checklist item 1340 indicates a review and freeze of the process control plan for commercial scale-up. Checklist item 1342 indicates a review and freeze of the FMEA process, wherein results indicating high risk prioritization numbers have been addressed. Checklist item 1344 indicates a that the raw material available/specifications are in place. Checklist item 1346 indicates that an acceptable yield/rate has been demonstrated. Checklist item 1348 indicates the proper material handling/packaging capability. Checklist item 1350 indicates whether a hazard review has been completed.

Whether the cost targets for the project are still on track is indicated in checklist item 1352. Checklist item 1354 indicates whether all process modifications are complete. Checklist item 1356 indicates whether all required EHS approvals have been obtained. Whether the MSDS sheets have been properly updated is indicated in checklist item 1358. Whether any identified patent applications have been filed is indicated in checklist item 1360. Checklist item 1362 indicates whether the Gage R&R of the Quality Assurance tests have been established. Checklist item 1364 indicates whether the risk/benefit analysis and identified cost ramifications of supply change have been revisited.

In a similar manner as that described above, after all of the information requested in FIGS. 12-13 has been generated and/or received, a stage 4 tollgate 207 is conducted. As set forth above regarding stages 1-3, the stage tollgate typically includes analysis by various individuals charged with the responsibility of evaluating whether the proposed supplier introduction is worth pursuing at that time, with the information currently collected. In a preferred embodiment, tollgate participants for stage 4 include representatives from each of the following departments:

material/product sourcing, EHS, Technology, Manufacturing, Quality, and Product Stewardship. By obtaining approval from each of these representatives, the organization can be sure of address all concerns prior to proceeding with the introduction. If it is determined that the supplier change is not suitable for actual implementation, tollgate 4 is not passed and the project is either reworked in stages 1 -4 or canceled. However, if it is determined that the introduction is suitable for full production and implementation, the stage 4 tollgate is passed and the process proceeds to stage 5, more fully set forth below.

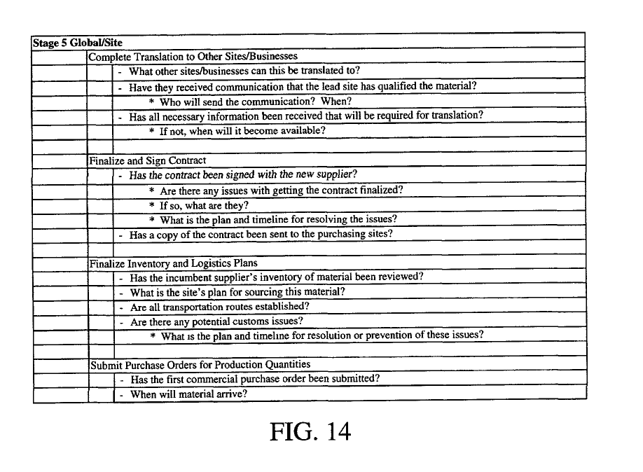

Referring now to FIG. 14, there is shown a hierarchical matrix depicting one preferred collection of milestones and checklist items associated with the Global/Site Section of stage 5 (208) set forth above generally relating to material purchase and production. Milestone 1400, the first milestone in the stage 5 Global/Site process, relates generally to completing the translation of the purchased material and specification to other sites/businesses. In a preferred embodiment, checklist item 1402 identifies what other sites/businesses the present material can be translated to. Checklist item 1404 indicates whether these sites/businesses have received communication that the lead site has qualified the material. If not, checklist item 1406 identifies when and by whom such a notification will be made. Checklist item 1408 indicates whether all required translation information has been received. If not, checklist item 1410 indicates when such information will become available.

Milestone 1412 relates to the finalization and execution of the contract with the new supplier. Whether such a contract has been signed is indicates in checklist item 1414. If not, any issues related to obtaining such a signature are identified in checklist item 1416. Further, a plan and timeline for the resolution of such issues are defined in checklist item 1418. Checklist item 1420 indicates whether a copy of the contract been sent to the purchasing site(s).

Milestone 1422 relates to finalizing the inventory and logistics plans. In particular, in checklist item 1424, it is indicated whether the incumbent supplier”s inventory of material has been reviewed. The site”s plan for sourcing this material is defined in checklist item 1426. Whether all of the transportation routes have been established is indicated in checklist item 1428. Further, any potential customs issues are identified in checklist item 1430. Any plans to prevent the issues are defined in checklist item 1432.

Milestone 1434 relates to the actual submission of a purchase order for production quantities of the material. Checklist item 1436 indicates whether the first commercial purchase order has been submitted. If so, when the first shipment will arrive is indicated in checklist item 1438.

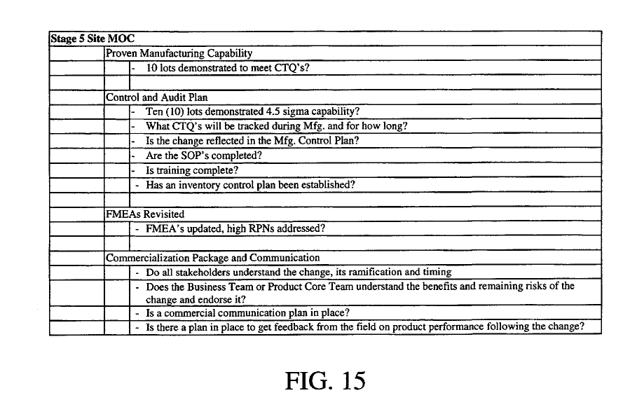

Referring now to FIG. 15, there is shown a hierarchical matrix depicting one preferred collection of milestones and checklist items associated with the Site MOC Section of stage 5 set forth above. Milestone 1500 and associated checklist item 1502 indicate whether the required manufacturing capability has been established through the production of 10 lots which have been demonstrated to meet the required CTQ”s. Milestone 1504 relates to a control and audit devised for ensuring that areas of risk have backup plans in production as well as a plan to periodically review the production data to look for trends that might indicate production defects or other issues. In particular, checklist item 1506 indicates whether ten lots have demonstrated a sigma capability of 4.5 (for Zst, this equates to approximately 3.4 DPMO). The various CTQ”s that will be tracked during manufacturing and how long they will be tracked is set forth in checklist item 1508. Checklist item 1510 indicates whether all of the standard operating procedures (SOP”s) have been completed. Whether training has been completed is indicated in checklist item 1512. Further, whether an inventory control has plan been established is indicated in checklist item 1514.

Milestone 1516 relates to the FMEA”s initially defined above in stage 3. In particular, checklist item 1518 indicates whether the FMEA”s have been updated, and the high RPN”s addressed. Milestone 1520 relates to commercialization package and communication. In a preferred embodiment, related checklist item 1522 indicates whether all stakeholders understand the change, its ramification and timing. Checklist item 1524 indicates all relevant personnel understand the benefits and remaining risks associated with the change and endorse these benefits and risks. Checklist item 1526 indicates whether a commercial communication plan is in place. A commercial communication plan refers to whether the change is to be communicated to the customer as well as the manner for this communication. Checklist item 1528 indicates whether a plan is in place for obtaining feedback from the field on the product performance following the change.

Once all of the required information requested in FIGS. 14 and 15 has been generated and/or received, a stage 5 tollgate 209 is conducted. As set forth above regarding stages 1-4, the stage tollgate typically includes analysis by various individuals charged with the responsibility of evaluating whether the proposed supplier introduction is worth pursuing at that time, with the information currently collected. In a preferred embodiment, tollgate participants for stage 5 include representatives from each of the following departments: material/product sourcing, Technology, Manufacturing, and Quality. By obtaining approval from each of these representatives, the organization can be sure of address all concerns prior to continuing with production. If it is determined that the supplier change is not suitable for further or continued production, tollgate 5 is not passed and the project is either reworked in stages 1-5 or canceled. However, if it is determined that the introduction is suitable for continued, long-term production, the stage 5 tollgate is passed and the process proceeds to stage 6, more fully set forth below.

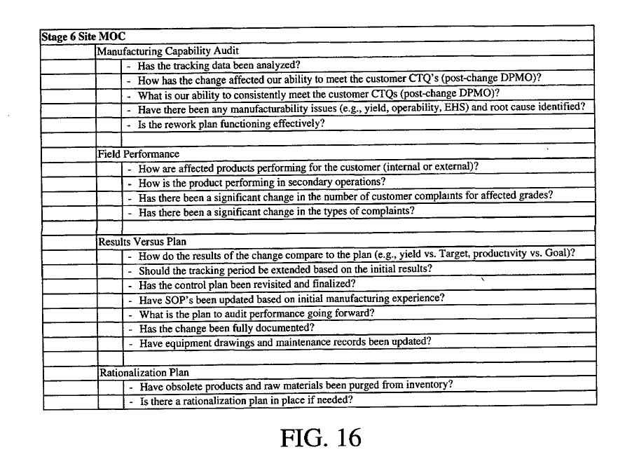

Referring now to FIG. 16, there is shown a hierarchical matrix depicting one preferred collection of milestones and checklist items associated with the Site MOC Section of stage 6 (210) set forth above generally relating to performance monitoring. Milestone 1600, the first milestone of the six stage relates to a manufacturing capability audit performed so as to determine the long term capabilities with respect to the project. In a preferred embodiment, checklist item 1602 indicates whether the various data tracked during manufacturing have been analyzed. Checklist item 1604 indicates the affect of the change on meeting any customer CTQ”s in post change DPMO”s (defects per million opportunities). Checklist item 1606 indicates the ability to consistently meet the customer CTQ”s is also defined in post-change DPMO”s. Any manufacturability issues (e.g., yield, operability, EHS) and the root cause thereof are identified in checklist item 1608. Whether or not the rework plan is functioning effectively is indicated in checklist item 1610.

Milestone 1612 relates generally to a field performance assessment conducted so as to monitor the performance of the product in the field. In particular, in checklist item 1614, an indication is received as to how the affected products are performing for the customer (internal or external). Checklist item 1616 indicates how the product performing is in secondary operations. Checklist item 1618 indicates whether there have been a significant change in the number of customer complaints for affected grades. Further, checklist item 1620 indicates whether there has been a significant change in the types of complaints being received.

Milestone 1622 relates generally to a comparison of the actual results to the planned results. In checklist item 1624, an indication is received as to how the results of the change compare to the plan (e.g., yield vs. Target, productivity vs. Goal). Checklist item 1626 identifies whether the tracking period should be extended based on the initial results. Checklist item 1628 indicates whether the control plan has been revisited and finalized. Checklist item 1630 indicates whether the SOP”s have been updated based on initial manufacturing experience. The continued plan to audit performance in the future is define in checklist item 1632. Further, whether the equipment drawings and maintenance records have been updated is indicated in checklist item 1634. Milestone 1636 relates generally to a rationalization plan for replacing old products/materials with the new product/material. In a preferred embodiment, checklist item 1638 indicates whether any obsolete products and raw materials have been purged from inventory. Checklist item 1640 indicates whether a rationalization plan is in place if needed.

Once all of the required information requested in FIG. 16 has been generated and/or received, a stage 6 tollgate 211 is conducted. As set forth above regarding stages 1-5, the stage tollgate typically includes analysis by various individuals charged with the responsibility of evaluating whether the proposed supplier introduction is worth pursuing at that time, with the information currently collected. In a preferred embodiment, tollgate participants for stage 6 include representatives from each of the following departments: material/product sourcing, Technology, Manufacturing, and Quality. By obtaining approval from each of these representatives, the organization can be sure of address all concerns prior to closing out the new supplier introduction project. If it is determined that issues are present which prevent the closing of the project, tollgate 6 is not passed and the identified issues are addressed and resolved. However, if it is determined that the all issues have been resolved to the representatives” satisfaction, the stage 6 tollgate is passed and the project is considered closed.

By providing a uniform process for introducing a new material supplier in a product design/manufacturing system, the system and method of the present invention substantially decreases the likelihood of errors being made which introduce costs in both time, resources, and risk. Further, the present system, through its comprehensive, global nature, substantially increases the ability for distributed locations to stay in tune with what each other are doing. Because all suppliers in every location must be introduced in accordance with the above system, added consistency results. In addition to consistency, the above described invention further provides for a uniform system of record for all attempted supplier introductions. Consequently, future developers may more easily determine if a similar introduction has been done previously.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents. cm What is claimed is

1. A method for introducing a new supplier into a product design and manufacturing system, comprising the steps of:
initiating a new supplier introduction process;
receiving new supplier information relating to the new supplier;
receiving material information relating to a particular material to be supplied;
receiving product information relating to a particular product to be manufactured which will include the particular material;
progressing through a series of supplier introduction stages wherein the new supplier introduction is progressed from initiation through manufacture/implementation;
receiving information relative to each stage in the series of introduction stages;
holding a stage tollgate for each stage in the series of introduction stages;
determining, in each stage in the series of introduction stages, whether the new supplier introduction process should advance from a current stage to a next stage.

2. The method of claim 1, wherein the step of progressing through a series of supplier introduction stages further comprises the steps of:
progressing through a first stage relating to identification and inception of a new supplier introduction program;
progressing through a second stage relating to a launch of the new supplier introduction program;
progressing through a third stage relating to material qualification for the material to be supplied by the new supplier;
progressing through a fourth stage relating to scale-up and customer sampling of products made using the material to be supplied by the new supplier;
progressing through a fifth stage relating to purchasing and implementation of the material; and
progressing through a sixth stage relating to monitoring the performance of the material supplied by the new supplier.

3. The method of claim 2, wherein the step of progressing through a first stage relating to identification and inception of the new supplier introduction program further comprises the steps of:
determining whether a first stage tollgate should be passed indicating that the new supplier initiative has been approved for introduction;
permitting advancement to the second stage if it is determined that the first stage tollgate has been passed.

4. The method of claim 2, wherein the step of progressing through a second stage relating to a launch of the new supplier introduction program further comprises the steps of:
determining whether a second stage tollgate should be passed indicating that the new supplier introduction has been approved for further development;
permitting advancement to the third stage if it is determined that the second stage tollgate has been passed.

5. The method of claim 2, wherein the step of progressing through a third stage relating to material qualification program further comprises the steps of:
determining whether a third stage tollgate should be passed indicating that the material to be supplied by the new supplier has been qualified;
permitting advancement to the fourth stage if it is determined that the third stage tollgate has been passed.

6. The method of claim 2, wherein the step of progressing through a fourth stage relating to scale-up and customer sampling further comprises the steps of:
determining whether a fourth stage tollgate should be passed indicating that scale-up samples have met customer approval;
permitting advancement to the fifth stage if it is determined that the fourth stage tollgate has been passed.

7. The method of claim 2, wherein the step of progressing through a fifth stage relating to purchase and implementation of the new material further comprises the steps of:
determining whether a fifth stage tollgate should be passed indicating that any issues and concerns regarding production have been adequately addressed;
permitting advancement to the sixth stage if it is determined that the fifth stage tollgate has been passed.

8. The method of claim 2, wherein the step of progressing through a sixth stage relating to performance monitoring further comprises the steps of:
determining whether a sixth stage tollgate should be passed indicating that any issues have been resolved and the program should be closed;
closing the program if it is determined that the sixth stage tollgate has been passed.

9. The method of claim 2, wherein the step of progressing through a first stage relating to identification and inception of a new supplier introduction program, further comprises the steps of:
initiating a global specification process;
analyzing environmental health and safety related risks;
assessing the effects of the new supplier on customers;
identifying required technical customer needs which relate to the new supplier; and
conducting a new supplier risk assessment to explore the potential external and internal risks and benefits.

10. The method of claim 2, wherein the step of progressing through a second stage relating to a launch of the new supplier introduction program, further comprises the steps of:
reviewing a questionnaire related to environmental health and safety for completeness and required follow-up activities;
evaluating the project for compliance with applicable food/medical/toy regulations;
developing a project timeline and resourcing plan; and
conducting a project risk assessment.

11. The method of claim 2, wherein the step of progressing through a third stage relating to material qualification for the material to be supplied by the new supplier, further comprises the step of:
validating material test methods.

12. The method of claim 2, wherein the step of progressing through a fourth stage relating to scale-up and customer sampling of products made using the material to be supplied by the new supplier, further comprises the step of:
finalizing a global specification; and
obtaining any required agency approvals.

13. The method of claim 2, wherein the step of progressing through a fifth stage relating to purchasing and implementation of the material, further comprises the steps of:
translating the material to additional sites or businesses;
determining whether the new supplier has demonstrated manufacturing capability; and
developing a control and audit plan.

14. The method of claim 2, wherein the step of progressing through a sixth stage relating to monitoring the performance of the material supplied by the
new supplier, further comprises the steps of:
conducting a manufacturing capability audit; and determining field performance of the material.
